(19) United States
(12) Patent Application Publication
(10) Pub. No.: US 2019/0084695 A1
(43) Pub. Date: Mar. 21, 2019

(54) Magneto-Electric Propulsion System

(71) Applicant: Harold Ellis Ensle, Arvada, CO (US)

(72) Inventor: Harold Ellis Ensle, Arvada, CO (US)

(21) Appl. No.: 15/708,286

(22) Filed: Sep. 19, 2017

(51) Int. Cl. B64G 1/40

(52) U.S. Cl. CPC B64G 1/409; H01G 4/30

(57) ABSTRACT

A system for propelling craft which is applicable in any environment. It employs alternating electric fields supplied by a multi-layer capacitor to create an alternating magnetic field. A coil is situated so that the magnetic field interacts with the current elements in the coil. The capacitor is charged and discharged in synchronization with the alternating current in the coil. The changing electric fields in the capacitor create a magnetic field that applies a force to the current elements in the coil which is then transferred to the body of the device. Any reactive force from the magnetic field of the coil is negated since the gaps in the capacitor have no current elements with which the magnetic field of the coil can interact. Therefore the device is propelled in a single direction.

### BACKGROUND

Currently the primary propulsion of craft that is generally applicable to all environments such as in air or space is rocket propulsion. While used with moderate success, this method has been commonly known to have serious limitations. The need to eject mass at high velocities requires enormous energy and the mass needs to be supplied by the craft, particularly if no substance is available from the environment (for example, in the vacuum of space). As distance and velocity requirements increase, the percentage of the weight of the craft that must be allocated to fuel storage becomes unacceptably large. Even when the craft is not accelerating, for example, if hovering at some constant distance from the ground, a large amount of energy still has to be expended to maintain position.

### SUMMARY

The invention of the present application is a system for propelling craft which is applicable in any environment. This has advantage over typical propulsion methods as no mass needs to be ejected. The system employs a stacked capacitor with an even number of plates. The capacitor is charged and discharged to create a changing electric field within the capacitor. This in turn creates a magnetic field around the capacitors. The dielectric in the stacked capacitor can be a non-conductive ferromagnetic material (ferrite). A coil is wrapped around the capacitor so that the direction of the current elements is perpendicular to the plane of the plates in the stacked capacitor. Thus the segments of the current (and surface current if a ferromagnetic dielectric is employed) interact with the magnetic fields generated by the changing electric field in the stacked capacitor. The capacitors are charged and discharged by alternating current in synchronization with the current in the coil. If the current is correctly synchronized and the capacitors and coil are correctly aligned, the magnetic field from the capacitors will create a force on the current elements in the coil and ferromagnetic core in a single direction. This force is transferred to the body of the device and propels it as long as the alternating current is maintained The magnetic field created by the coil is missing some current elements (the gaps between the plates) in the capacitor with which to interact, so the capacitor is also propelled in the same direction by its physical attachment to the coil.

### DRAWINGS

FIG. 1 is the illustrative embodiment of a typical magneto-electric propulsion system.

FIG. 2 is the diagram of a possible circuit that could be used to power the magneto-electric propulsion system.

### DESCRIPTION OF THE ILLUSTRATIVE EMBODIMENT

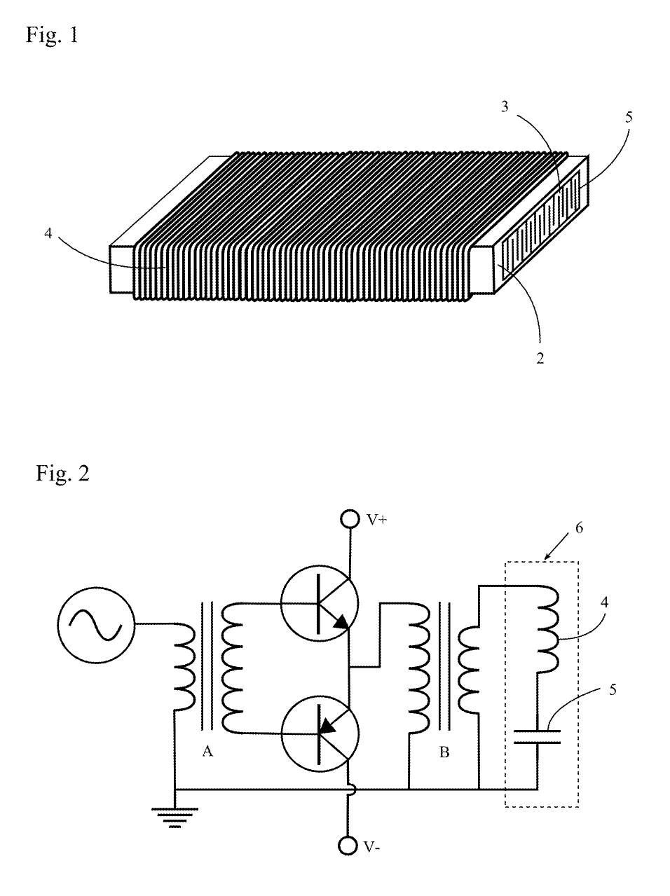

This embodiment (FIG. 1) is composed of a stacked (multi-layer) capacitor 5 and a coil 4 wrapped around the capacitor. The dielectric 3 in the capacitor can be a non-conductive ferromagnetic material which enhances the output of the device. The coil is aligned so that the wires are perpendicular to the plates. This gives two planes in which the coil can be wound. One would typically want to wrap the coil along the longer side (as shown in FIG. 1) so that it is more effective in magnetizing the ferromagnetic material. There is an insulating buffer 2 used to keep the coil from being too close to the capacitor, so that the current distribution in the capacitor is not disturbed from its normal flow. This insulating buffer can also be a non-conductive ferromagnetic material.

In this embodiment the coil is connected in series with the capacitor. This enforces the synchronization of the magnetic field generated by the capacitor with the current in the coil. An alternating current drives the device. While any frequency of alternating current would drive the device, it is most efficient to drive the coils and capacitors at their resonant frequency.

FIG. 2 represents a possible driving circuit for the magneto-electric propulsion system. The dotted square 6 encloses the electrical schematic of the components contained in the propulsion system as illustrated in FIG. 1. The coil 4 and ferromagnetic material 3 (displayed as the inductor 4 in FIG. 2) are connected in series to the capacitor 5 of FIG. 1. This is accomplished by attaching the leads from the coil to the appropriate conductive surface on the plates of the capacitor (these connections not illustrated in FIG. 1).

Notice that the circuit starts with an alternating voltage source where a transformer A is used to link and also increase the voltage for the AB class amplifier at which point the current is amplified. The transformer B can be used to further amplify the current (provided the resistance in the coil and capacitor of the device is low)

The inductor and capacitor arrangement in the magneto-electric propulsion system creates an LC or tank circuit and the initial alternating voltage is tuned to the resonant frequency of the LC circuit. Any wave shape of alternating current would suffice for the propulsion system to succeed. However, this particular driving circuit produces a sinusoidal varying current. This is substantially the simplest circuit that provides the means for synchronizing the alternating current and driving it at resonance. This is used as illustration and there is a wide variety of possible circuits that could be designed to drive the propulsion system.

Looking at FIG. 1, the changing electric fields in the capacitor 5 create a magnetic field that applies a force to the current elements, both free (the coil 4) and bound (ferromagnetic material 3) created by the coil 4 which is then transferred to the body of the device. When the charge on the capacitor reverses, the current of coil 4 reverses at the same time, thus the net force is always in the same direction.

There is one additional detail. The fluctuating magnetic field of the coil creates a force on the charge on the end plate of each side of the capacitor. This force is in the opposite direction of the magnetic force on the coil. This force is of comparable strength, but is diminished as the number of plates in the capacitor is increased. Ultimately the length of the capacitor perpendicular to the direction of the plates must exceed the width of the end plate (the direction of the width being along the direction of the coil wires at that point) in order to overcome this counter force.

While an illustrative embodiment has been displayed and described, various modifications and substitutions may be made thereto without departing from the spirit and scope of the present invention. Accordingly, it is to be understood that the present invention has been described by way of illustration and not limitation

What is claimed as new is:

1. A propulsion system comprising:
c. a stacked or multi-layer capacitor,
d. a means to charge and discharge said capacitor, and
a. a coil wrapped around said capacitor such that the wires of said coil are perpendicular to the plates in said capacitor,
b. a means to drive an alternating current through said coil,
e. a means to synchronize the charging of said capacitor with the alternating current in said coil so that they are at the same frequency and that, when said capacitor is fully charged the current through said coil is substantially zero,
whereby the force on the current elements of said coil generated by the magnetic field arising from the change in the electric fields of said capacitor results in a net force which is always in the same direction and said system is propelled in a single direction.

2. The propulsion system of claim 1 wherein said capacitor and said coil are electrically connected in series to provide means to synchronize the variation of charge in said capacitor and alternating current of said coil.

3. The propulsion system of claim 2 wherein means are provided to drive said alternating current at the resonant frequency based on the capacitance of said capacitor and inductance of said coil.

4. The propulsion system of claim 1 wherein said capacitor has a dielectric made from a non-conductive ferromagnetic material.
